(19) United States
(12) Patent Application Publication
(10) Pub. No.: US 2013/0036847 A1
(43) Pub. Date: Feb. 14, 2013

(54) GATE-TYPE SLIDE MECHANISM

(71) Applicants: AN SZU HSU, NEW TAIPEI CITY (TW); HUNG SHUN LIU, NEW TAIPEI CITY (TW); CHIEN NAN TSAI, NEW TAIPEI CITY (TW)

(72) Inventors: AN SZU HSU, NEW TAIPEI CITY (TW); HUNG SHUN LIU, NEW TAIPEI CITY (TW); CHIEN NAN TSAI, NEW TAIPEI CITY (TW)

(73) Assignee: FIRST DOME CORPORATION, NEW TAIPEI CITY (TW)

(21) Appl. No.: 13/206,551

(22) Filed: Aug. 10, 2011

(51) Int. Cl. F16H 21/44

(52) U.S. Cl. 74/100.1

(57) ABSTRACT

A gate-type slide mechanism includes a first slide seat, a second slide seat having rack sections on two sides and slidably connected to the first slide seat, and a base seat slidable relative to the first slide seat. Two pivot pins are arranged on the first slide seat near two sides of the second slide seat. Two elastic extensible/compressible assemblies are pivotally disposed between two ends of the base seat and the pivot pins. The elastic extensible/compressible assemblies are pivotally rotatable around the pivot pins and elastically extensible/compressible with the sliding of the base seat to apply a resistance or aid force to the base seat. Two toothed members are disposed at the ends of the elastic extensible/compressible assemblies proximal to the second slide seat for engaging with the rack sections thereof and driving the second slide seat to slide in a direction reverse to that of the base seat.

### BACKGROUND OF THE INVENTION

1. Field of the Invention

The present invention relates generally to a gate-type slide mechanism, and more particularly to a gate-type slide mechanism, which can slide stably. Moreover, the gate-type slide mechanism is connected with the flat cable between the relatively slidable components to keep the flat cable in a tensioned state.

2. Description of the Related Art

Following the development of various electronic products diversified in appearance and function, various slide cover structures have been developed and applied to different electronic devices. For example, Taiwanese Utility Model Patent Publication No. M392525 discloses a slide cover assembly and a slide cover electronic device. The slide cover assembly is disposed between the cover body and the main body of the electronic device. The slide cover assembly includes a support board connected with the cover body and a link board connected with the main body. A slide block is disposed in the support board. The slide block is connected with the link board via connection strings wound on locating poles of the support board. By means of the connection strings, the link board and the slide block always move relative to each other in reverse directions. The link board is slidably disposed on the support board. A torsion spring assembly is disposed between the link board and the middle section of the support board. The torsion spring assembly can be twisted or untwisted to different extents with the change of the position of the link board so as to provide push aid and buffering effect for the link board. The flat cable of the main body passes through the support board to connect with the slide block. Accordingly, when the link board and the slide block slide relative to each other, the flat cable is driven by the slide block and is gradually straightened or folded to keep in a tensioned state. Accordingly, the flat cable is prevented from loosening due to change of relative positions of the cover body and the main body.

In the above structure, the linear metal torsion elastic members are used to provide necessary driving force for the slide cover. Such structure is practically applicable to small-size electronic products with small-volume and lightweight slide cover, such as cellular phones, handheld game machines and personal digital assistants (PDA). However, such structure can be hardly applied to a large-size electronic product such as a laptop computer or a tablet computer. This is because the movable system will have a heavier weight and it is necessary to move the movable system through a longer distance. Accordingly, inevitably, it is necessary to use elastic members with larger elastic coefficient to provide sufficient elastic force. As a result, when the slide cover slides to the end of the travel, a greater impact is applied to the slide cover. This is very likely to cause damage and failure of the slide cover.

### SUMMARY OF THE INVENTION

It is therefore a primary object of the present invention to provide a gate-type slide mechanism, which can slide stably. Moreover, the gate-type slide mechanism is connected with the flat cable between the relatively slidable components to avoid laxity of the flat cable and keep the flat cable in a tensioned state. Accordingly, the flat cable will not affect the sliding movement of the slide cover.

It is a further object of the present invention to provide the above gate-type slide mechanism, which is applicable to both small-size and large-size electronic products. Therefore, the gate-type slide mechanism has a wide application range.

To achieve the above and other objects, the gate-type slide mechanism of the present invention includes a first slide seat; a gate-type second slide seat slidably disposed on the first slide seat; and at least one elastic extensible/compressible assembly pivotally disposed at a middle section of the first slide seat in adjacency to one side of the second slide seat. A first end of elastic extensible/compressible assembly abuts against the second slide seat and is synchronously movable with the second slide seat. A second end of the elastic extensible/compressible assembly is pivotally connected with a base seat. The base seat is movable relative to the first slide seat.

In the above gate-type slide mechanism, the second slide seat has a rack section disposed on one side proximal to the extensible/compressible assembly. A toothed member is disposed at the first end of the extensible/compressible assembly in adjacency to the second slide seat. The toothed member is engaged with the rack section in an engagement position. When the extensible/compressible assembly is pivotally rotated, the engagement position between the toothed member and the rack section is changed, whereby the second slide seat is driven to slide in a direction reverse to that of the base seat. Accordingly, the second slide seat can be connected to a displaceable section of the relevant flat cable to drive the flat cable to move with the sliding movement of the base seat so as to keep the flat cable in a tensioned state.

In the above gate-type slide mechanism, a periphery of the toothed member is at least partially formed with a toothed section for engaging with the rack section.

In the above gate-type slide mechanism, the toothed member has a protrusion section. The protrusion section passes through the first end of the extensible/compressible assembly, whereby the toothed member is extensibly/retractably slidably connected with the first end of the extensible/compressible assembly.

In the above gate-type slide mechanism, the first end of the extensible/compressible assembly is formed with an end toothed section. The toothed member has a first gear section and a second gear section. The first gear section is engaged with the end toothed section, while the second gear section is engaged with the rack section.

In the above gate-type slide mechanism, the first and second gear sections are concentric with each other.

In the above gate-type slide mechanism, the extensible/compressible assembly has a connection member disposed at the first end of the extensible/compressible assembly for connecting with the toothed member. The extensible/compressible assembly further has a pivotal connection member disposed at the second end of the extensible/compressible assembly. The pivotal connection member is pivotally disposed on the base seat. At least one elastic member is disposed between the connection member and the pivotal connection member.

In the above gate-type slide mechanism, the elastic member is fitted around a guide rod. One end of the guide rod is affixed to the pivotal connection member, while the other end of the guide rod passes through the connection member, whereby the connection member is reciprocally slidable along the guide rod to compress the elastic member.

In the above gate-type slide mechanism, the first slide seat has first and second slide guide sections in parallel to each other. The second slide seat is connected to the second slide guide section and reciprocally slidable along the second slide guide section in an extension direction thereof. The base seat is connected to the first slide guide sections and reciprocally slidable along the first slide guide sections in an extension direction thereof.

In the above gate-type slide mechanism, the second slide guide section is a hollow slot and the second slide seat has a raised section corresponding to the hollow slot. The raised section is slidably inlaid in the hollow slot.

In the above gate-type slide mechanism, the first slide guide sections are disposed on two sides of the first slide seat and the base seat has connection sections for fitting with the first slide guide sections.

The present invention can be best understood through the following description and accompanying drawings, wherein:

### BRIEF DESCRIPTION OF THE DRAWINGS

FIG. 1 is a perspective exploded view of a first embodiment of the present invention;

FIG. 2 is a perspective assembled view of the first embodiment of the present invention;

FIG. 3 is a plane view showing the operation of the first embodiment of the present invention in one state;

FIG. 4 is a plane view showing the operation of the first embodiment of the present invention in another state;

FIG. 5 is a perspective exploded view of a second embodiment of the present invention;

FIG. 6 is a perspective assembled view of the second embodiment of the present invention;

FIG. 7 is a plane view showing the operation of the second embodiment of the present invention in one state; and

FIG. 8 is a plane view showing the operation of the second embodiment of the present invention in another state.

### DETAILED DESCRIPTION OF THE PREFERRED EMBODIMENTS

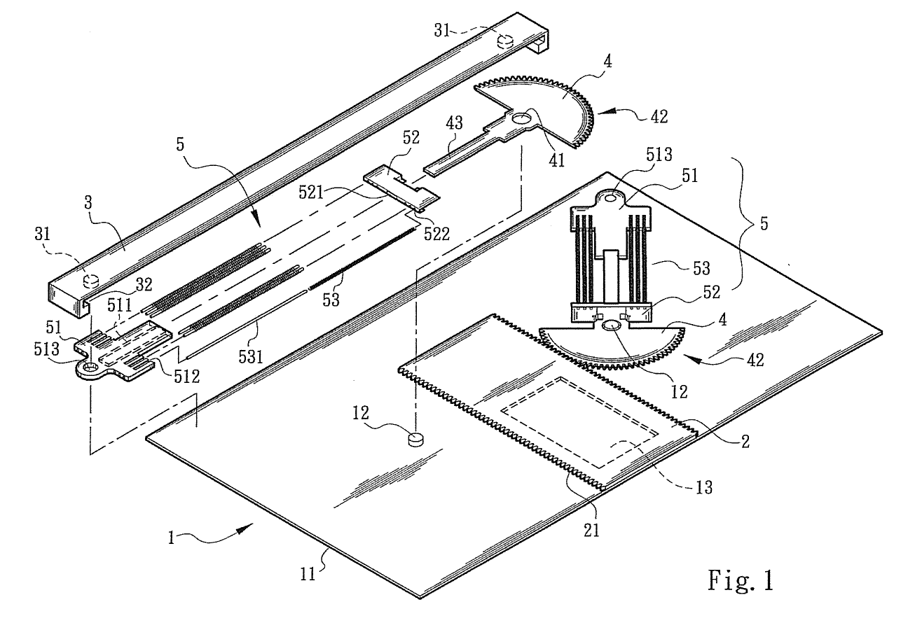

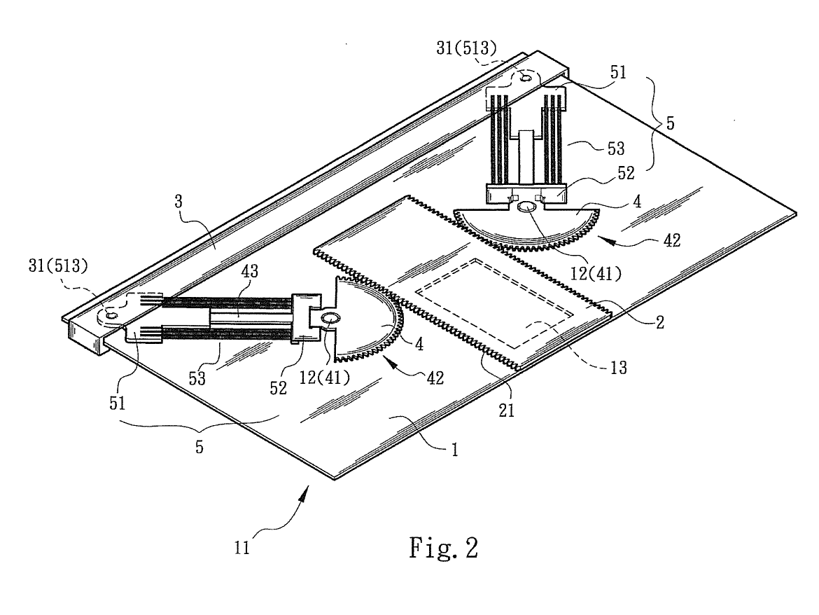

Please refer to FIGS. 1 to 4. According to a first embodiment, the present invention includes a first slide seat 1, a second slide seat 2, a base seat 3, toothed members 4 and elastic extensible/compressible assemblies 5. The first slide seat 1 has two first slide guide sections 11 disposed on two sides of the first slide seat 1. The first slide seat 1 further has a second slide guide section 13, (which can be a hollow slot), disposed in a middle section of the first slide seat 1. Two first pivot pins 12 are arranged in the middle section of the first slide seat 1 in adjacency to two sides of the second slide guide section 13 respectively. The second slide seat 2 is connected to the second slide guide section 13. (For example, the second slide seat 2 can have a corresponding raised section, which is directly inlaid in the hollow slot). Accordingly, the second slide seat 2 can reciprocally slide along the second slide guide section 13 (hollow slot) in an extension direction thereof. Two rack sections 21 are disposed on two sides of the second slide seat 2 respectively. Each rack section 21 is composed of multiple teeth. The base seat 3 has two connection sections 32 disposed on two sides of the base seat 3 respectively. The connection sections 32 are fitted on the first slide guide sections 11 of the first slide seat 1, whereby the base seat 3 can reciprocally slide along the first slide guide sections 11 in an extension direction thereof. Two second pivot pins 31 are disposed on two sides of the base seat 3 respectively. The elastic extensible/compressible assemblies 5 are elastic bodies arranged between the first and second pivot pins 12, 31. Each elastic extensible/compressible assembly 5 includes a pivotal connection member 51, a connection member 52 and multiple elastic members 53 disposed between the pivotal connection member 51 and the connection member 52. The pivotal connection member 51 is formed with a pivot hole 513 in which the second pivot pin 31 of the base seat 3 is pivotally fitted. A recess 511 is formed on one face of the pivotal connection member 51. In addition, the pivotal connection member 51 is formed with multiple locating channels 512 positioned on two sides of the recess 511. The connection member 52 is formed with a through hole 521 and multiple perforations 522 corresponding to the recess 511 and the locating channels 512 respectively. Each elastic member 53 is fitted around a guide rod 531. A first end of the guide rod 531 is affixed to the locating channel 512, while a second end of the guide rod 531 passes through the perforation 522. Accordingly, the connection member 52 can reciprocally slide along the guide rods 531 to compress the elastic members 53. Each toothed member 4 has an arcuate toothed section 42 disposed on a part of the periphery of the toothed member 4. The toothed section 42 is composed of multiple teeth, whereby the toothed section 42 can be engaged with the rack section 21. The toothed member 4 is formed with a pivot hole 41 positioned at a center of the arcuate toothed section 42. The first pivot pin 12 is fitted in the pivot hole 41. The toothed member 4 further has a protrusion section 43 extending from one side of the toothed member 4, which side is distal from the toothed section 42. The protrusion section 43 passes through the through hole 521 and extends into the recess 511. Accordingly, the toothed member 4 is assembled and connected with one end of the elastic extensible/compressible assembly 5, which end is proximal to the second slide seat 2.

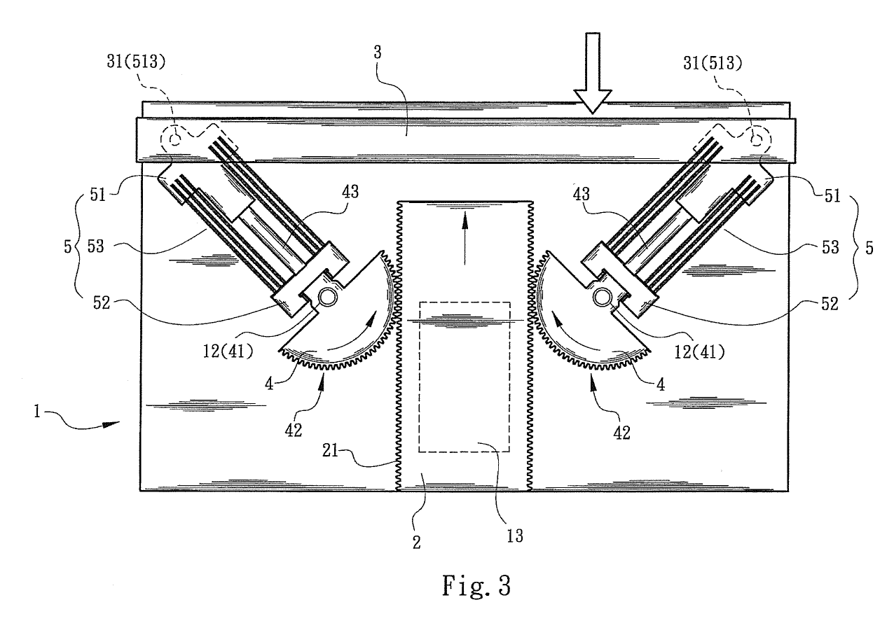

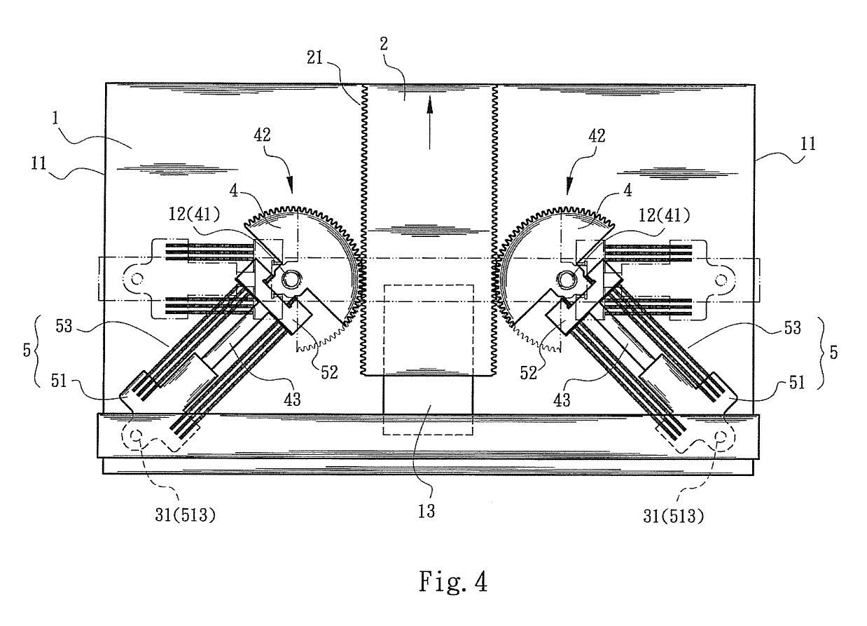

In practice, the base seat 3 can be connected with a main body of an electronic device (such as a mobile phone or a PDA) as necessary. The first slide seat 1 can be connected with a slide cover of the electronic product. When the slide cover covers the main body of the electronic product, the base seat 3 is positioned at one end of the first slide guide section 11 of the first slide seat 1 (as shown in FIG. 3). In use, when pushing open the slide cover, the first slide seat 1 is driven to slide relative to the base seat 3. In the meantime, the base seat 3 drives the two elastic extensible/compressible assemblies 5 and the toothed members 4 to pivotally rotate. During the pivotal rotation process of the extensible/compressible assemblies 5, the base seat 3 is relatively slid to the middle section of the first slide guide section 11 and the elastic members 53 are first compressed to store energy. Under such circumstance, a resistance is applied to the slide cover against the sliding movement thereof. Then, when the base seat 3 is relatively slid to the other end of the first slide guide section 11, the elastic members 53 are decompressed to release the energy and help in pushing the slide cover (as shown in FIG. 4). When the extensible/compressible assembly 5 is pivotally rotated around the first pivot pin 12 with the sliding movement of the base seat 3, the toothed section 42 of the toothed member 4 is also pivotally rotated around the first pivot pin 12 to change the engagement position with the rack section 21. In this case, the second slide seat 2 is driven to slide in a direction reverse to that of the base seat 3. (This is similar to the movement of the slide block or gate of the aforesaid Taiwanese Utility Model Patent Publication No. M392525). Accordingly, the second slide seat 2 can be connected to a displaceable section of the relevant flat cable as necessary. Under such circumstance, the second slide seat 2 can drive the flat cable to move with the sliding movement of the base seat 3 so as to release or tension the flat cable and avoid laxity of the flat cable. In this case, the flat cable will not affect the opening of the slide cover.

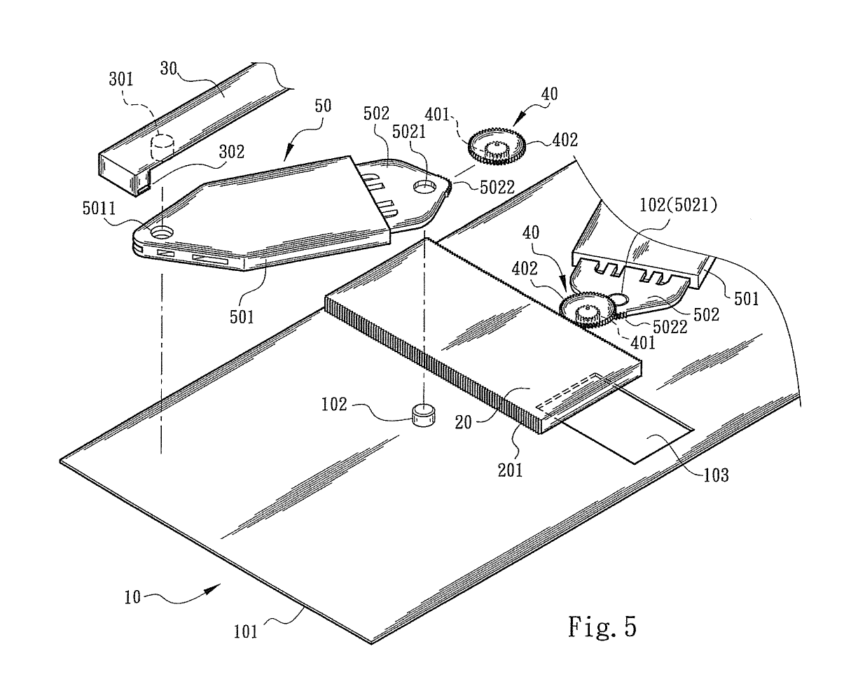

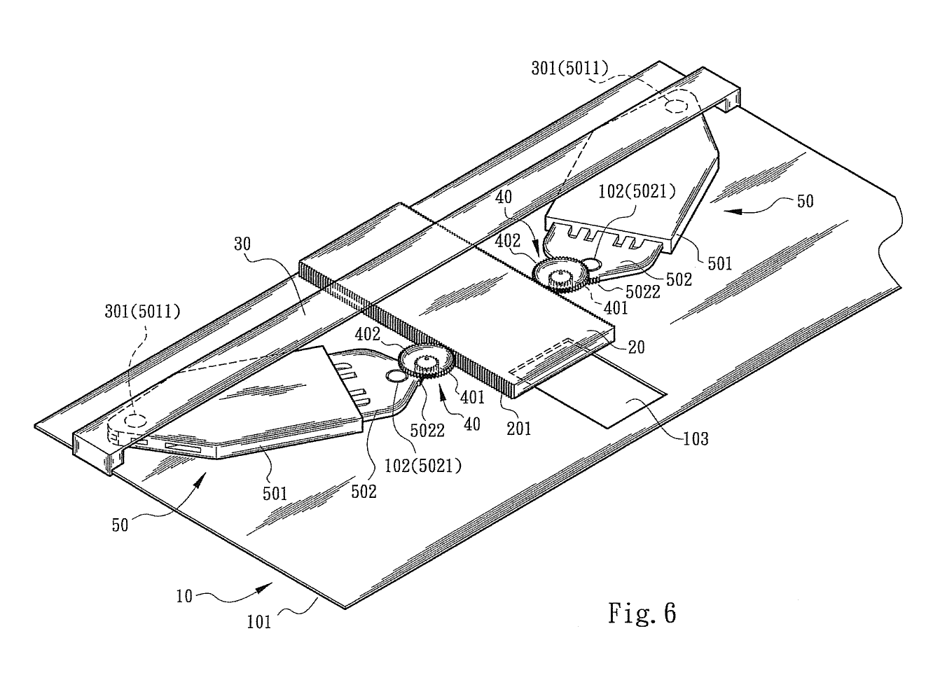

Please refer to FIGS. 5 to 8. According to a second embodiment, the present invention includes a first slide seat 10, a second slide seat 20, a base seat 30, two toothed members 40 and two extensible/compressible assemblies 50. The first slide seat 10 has two first slide guide sections 101, two first pivot pins 102 and a second slide guide section 103 as the first slide seat 1. The second slide seat 20 has two rack sections 201 similar to the rack sections 21 of the second slide seat 2. Also, the base seat 30 has two connection sections 302 and two second pivot pins 301 as the base seat 3. The first slide seat 10, the second slide seat 20 and the base 30 are connected with each other as the first embodiment. Each extensible/compressible assembly 50 includes a pivotal connection member 501 and a connection member 502. Elastic members (not shown) are disposed between the pivotal connection member 501 and the connection member 502. The elastic members are elastically extensible/compressible between the pivotal connection member 501 and the connection member 502. The pivotal connection member 501 is formed with a pivot hole 5011 in which the second pivot pin 301 of the base seat 30 is pivotally fitted. The center of the connection member 502 is formed with a through hole 5021 in which the first pivot pin 102 is fitted. An end toothed section 5022 is formed on a periphery of the connection member 502. The end toothed section 5022 is composed of multiple teeth. The toothed member 40 is a complex gear including a first gear section 401 and a second gear section 402, which are concentric with each other and have different tooth numbers. The first gear section 401 is engaged with the end toothed section 5022, while the second gear section 402 is engaged with the rack section 201.

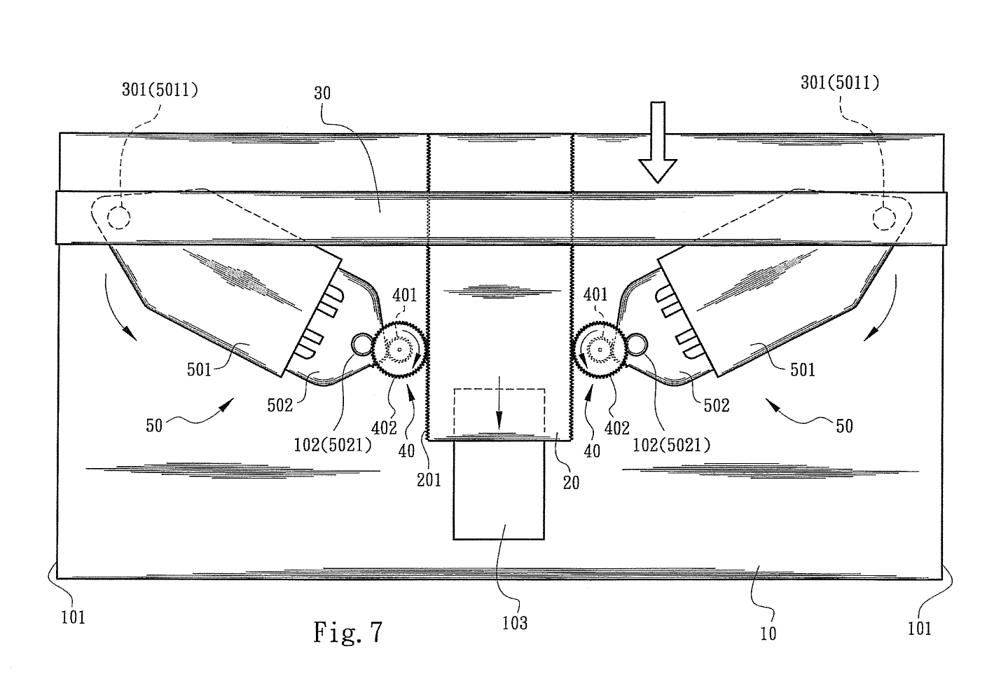

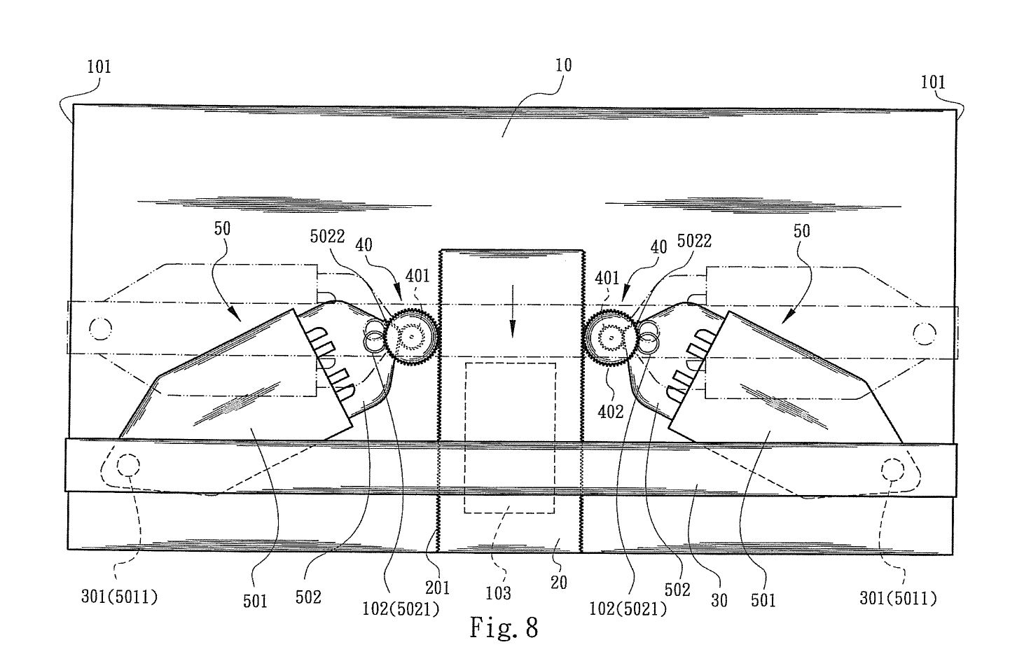

In practice, when the slide cover (connected with the first slide seat 10) covers the main body (connected with the base seat 30) of the electronic product, the base seat 30 is positioned at one end of the first slide guide section 101 (as shown in FIG. 7). In use, when pushing open the slide cover, the first slide seat 10 is driven to slide relative to the base seat 30. In the meantime, the base seat 30 drives the two elastic extensible/compressible assemblies 50 to pivotally rotate. During the pivotal rotation process of the extensible/compressible assemblies 50, the elastic members of the extensible/compressible assemblies 50 are first compressed to store energy and then decompressed to release the energy (as shown in FIG. 8). Accordingly, a buffering effect and a push aid effect are provided for the slide cover during the sliding movement thereof. When the extensible/compressible assembly 50 is pivotally rotated around the first pivot pin 102 with the sliding movement of the base seat 30, the end toothed section 5022 of the extensible/compressible assembly 50 drives the toothed member 40 to rotate via the first gear section 401. At the same time, via the rack section 201, the second gear section 402 of the toothed member 40 drives the second slide seat 20 to slide in a direction reverse to that of the base seat 30. Accordingly, as in the first embodiment, the second slide seat 20 can be connected to a displaceable section of the relevant flat cable to drive the flat cable to move with the sliding movement of the base seat 30 so as to release or tension the flat cable.

In conclusion, the gate-type slide mechanism of the present invention can be stably slid. Moreover, the gate-type slide mechanism of the present invention is connected with the flat cable between the relatively slidable components to always keep the flat cable in a tensioned state.

The above embodiments are only used to illustrate the present invention, not intended to limit the scope thereof. Many modifications of the above embodiments can be made without departing from the spirit of the present invention.

What is claimed is:

1. A gate-type slide mechanism comprising:
a first slide seat;
a second slide seat slidably disposed on the first slide seat; and
at least one elastic extensible/compressible assembly pivotally disposed at a middle section of the first slide seat in adjacency to one side of the second slide seat, a first end of elastic extensible/compressible assembly abutting against the second slide seat and being synchronously movable with the second slide seat, a second end of the elastic extensible/compressible assembly being pivotally connected with a base seat, the base seat being movable relative to the first slide seat.

2. The gate-type slide mechanism as claimed in claim 1, wherein the second slide seat has a rack section disposed on one side proximal to the extensible/compressible assembly, a toothed member being disposed at the first end of the extensible/compressible assembly in adjacency to the second slide seat, the toothed member being engaged with the rack section in an engagement position, when the extensible/compressible assembly is pivotally rotated, the engagement position between the toothed member and the rack section being changed, whereby the second slide seat is driven to slide in a direction reverse to that of the base seat.

3. The gate-type slide mechanism as claimed in claim 2, wherein a periphery of the toothed member is at least partially formed with a toothed section for engaging with the rack section.

4. The gate-type slide mechanism as claimed in claim 3, wherein the toothed member has a protrusion section, the protrusion section passing through the first end of the extensible/compressible assembly, whereby the toothed member is extensibly/retractably slidably connected with the first end of the extensible/compressible assembly.

5. The gate-type slide mechanism as claimed in claim 2, wherein the first end of the extensible/compressible assembly is formed with an end toothed section, the toothed member having a first gear section and a second gear section, the first gear section being engaged with the end toothed section, while the second gear section being engaged with the rack section.

6. The gate-type slide mechanism as claimed in claim 5, wherein the first and second gear sections are concentric with each other.

7. The gate-type slide mechanism as claimed in claim 1, wherein the extensible/compressible assembly has a connection member disposed at the first end of the extensible/compressible assembly for connecting with the toothed member, the extensible/compressible assembly further having a pivotal connection member disposed at the second end of the extensible/compressible assembly, the pivotal connection member being pivotally disposed on the base seat, at least one elastic member being disposed between the connection member and the pivotal connection member.

8. The gate-type slide mechanism as claimed in claim 2, wherein the extensible/compressible assembly has a connection member disposed at the first end of the extensible/compressible assembly for connecting with the toothed member, the extensible/compressible assembly further having a pivotal connection member disposed at the second end of the extensible/compressible assembly, the pivotal connection member being pivotally disposed on the base seat, at least one elastic member being disposed between the connection member and the pivotal connection member.

9. The gate-type slide mechanism as claimed in claim 3, wherein the extensible/compressible assembly has a connection member disposed at the first end of the extensible/compressible assembly for connecting with the toothed member, the extensible/compressible assembly further having a pivotal connection member disposed at the second end of the extensible/compressible assembly, the pivotal connection member being pivotally disposed on the base seat, at least one elastic member being disposed between the connection member and the pivotal connection member.

10. The gate-type slide mechanism as claimed in claim 5, wherein the extensible/compressible assembly has a connection member disposed at the first end of the extensible/compressible assembly for connecting with the toothed member, the extensible/compressible assembly further having a pivotal connection member disposed at the second end of the extensible/compressible assembly, the pivotal connection member being pivotally disposed on the base seat, at least one elastic member being disposed between the connection member and the pivotal connection member.

11. The gate-type slide mechanism as claimed in claim 7, wherein the elastic member is fitted around a guide rod, one end of the guide rod being affixed to the pivotal connection member, while the other end of the guide rod passing through the connection member, whereby the connection member is reciprocally slidable along the guide rod to compress the elastic member.

12. The gate-type slide mechanism as claimed in claim 8, wherein the elastic member is fitted around a guide rod, one end of the guide rod being affixed to the pivotal connection member, while the other end of the guide rod passing through the connection member, whereby the connection member is reciprocally slidable along the guide rod to compress the elastic member.

13. The gate-type slide mechanism as claimed in claim 1, wherein the first slide seat has first and second slide guide sections in parallel to each other, the second slide seat being connected to the second slide guide section and reciprocally slidable along the second slide guide section in an extension direction thereof, the base seat being connected to the first slide guide sections and reciprocally slidable along the first slide guide sections in an extension direction thereof.

14. The gate-type slide mechanism as claimed in claim 2, wherein the first slide seat has first and second slide guide sections in parallel to each other, the second slide seat being connected to the second slide guide section and reciprocally slidable along the second slide guide section in an extension direction thereof, the base seat being connected to the first slide guide sections and reciprocally slidable along the first slide guide sections in an extension direction thereof.

15. The gate-type slide mechanism as claimed in claim 3, wherein the first slide seat has first and second slide guide sections in parallel to each other, the second slide seat being connected to the second slide guide section and reciprocally slidable along the second slide guide section in an extension direction thereof, the base seat being connected to the first slide guide sections and reciprocally slidable along the first slide guide sections in an extension direction thereof.

16. The gate-type slide mechanism as claimed in claim 5, wherein the first slide seat has first and second slide guide sections in parallel to each other, the second slide seat being connected to the second slide guide section and reciprocally slidable along the second slide guide section in an extension direction thereof, the base seat being connected to the first slide guide sections and reciprocally slidable along the first slide guide sections in an extension direction thereof.

17. The gate-type slide mechanism as claimed in claim 7, wherein the first slide seat has first and second slide guide sections in parallel to each other, the second slide seat being connected to the second slide guide section and reciprocally slidable along the second slide guide section in an extension direction thereof, the base seat being connected to the first slide guide sections and reciprocally slidable along the first slide guide sections in an extension direction thereof.

18. The gate-type slide mechanism as claimed in claim 8, wherein the first slide seat has first and second slide guide sections in parallel to each other, the second slide seat being connected to the second slide guide section and reciprocally slidable along the second slide guide section in an extension direction thereof, the base seat being connected to the first slide guide sections and reciprocally slidable along the first slide guide sections in an extension direction thereof.

19. The gate-type slide mechanism as claimed in claim 11, wherein the first slide seat has first and second slide guide sections in parallel to each other, the second slide seat being connected to the second slide guide section and reciprocally slidable along the second slide guide section in an extension direction thereof, the base seat being connected to the first slide guide sections and reciprocally slidable along the first slide guide sections in an extension direction thereof.

20. The gate-type slide mechanism as claimed in claim 13, wherein the second slide guide section is a hollow slot and the second slide seat has a raised section corresponding to the hollow slot, the raised section being slidably inlaid in the hollow slot.

21. The gate-type slide mechanism as claimed in claim 14, wherein the second slide guide section is a hollow slot and the second slide seat has a raised section corresponding to the hollow slot, the raised section being slidably inlaid in the hollow slot.

22. The gate-type slide mechanism as claimed in claim 17, wherein the second slide guide section is a hollow slot and the second slide seat has a raised section corresponding to the hollow slot, the raised section being slidably inlaid in the hollow slot.

23. The gate-type slide mechanism as claimed in claim 18, wherein the second slide guide section is a hollow slot and the second slide seat has a raised section corresponding to the hollow slot, the raised section being slidably inlaid in the hollow slot.

24. The gate-type slide mechanism as claimed in claim 19, wherein the second slide guide section is a hollow slot and the second slide seat has a raised section corresponding to the hollow slot, the raised section being slidably inlaid in the hollow slot.

25. The gate-type slide mechanism as claimed in claim 13, wherein the first slide guide sections are disposed on two sides of the first slide seat and the base seat has connection sections for fitting with the first slide guide sections.

26. The gate-type slide mechanism as claimed in claim 14, wherein the first slide guide sections are disposed on two sides of the first slide seat and the base seat has connection sections for fitting with the first slide guide sections.
